(19) United States
(12) Patent Application Publication
(10) Pub. No.: US 2018/0335137 A1
(43) Pub. Date: Nov. 22, 2018

(54) Control Method For A Ball-Type CVT At Unity Speed Ratio

(71) Applicant: Dana Limited, Maumee, OH (US)

(72) Inventors: Jeffrey M. David, Cedar Park, TX (US); Gordon M. McIndoe, Volente, TX (US)

(21) Appl. No.: 15/985,925

(22) Filed: May 22, 2018

Related U.S. Application Data
(60) Provisional application No. 62/509,447, filed on May 22, 2017.

(51) Int. Cl. F16H 61/664; F16H 15/50

(52) U.S. Cl. CPC F16H 61/664; F16H 2059/147; F16H 15/503

(57) ABSTRACT

Provided herein is a vehicle including a continuously variable planetary (CVP), wherein the CVP is a ball-type variator assembly having an input traction ring assembly, an output traction ring assembly, and an idler assembly in contact with a plurality of balls, wherein each ball of the plurality of balls has a tiltable axis of rotation; and a controller configured to control a CVP speed ratio and apply a kinematic ratio constraint and a speed-based ratio constraint to a commanded CVP speed ratio near operation at unity speed ratio.

### RELATED APPLICATION

This application claims the benefit of U.S. Provisional Application No. 62/509,447 filed May 22, 2017, which is incorporated herein by reference in its entirety.

### BACKGROUND

Continuously variable transmissions (CVT) and transmissions that are substantially continuously variable are increasingly gaining acceptance in various applications. The process of controlling the ratio provided by the CVT is complicated by the continuously variable or minute gradations in ratio presented by the CVT. Furthermore, the range of ratios that are available to be implemented in a CVT are not sufficient for some applications. A transmission is capable of implementing a combination of a CVT with one or more additional CVT stages, one or more fixed ratio range splitters, or some combination thereof in order to extend the range of available ratios. The combination of a CVT with one or more additional stages further complicates the ratio control process, as the transmission will have multiple configurations that achieve the same final drive ratio.

The different transmission configurations can for example, multiply input torque across the different transmission stages in different manners to achieve the same final drive ratio. However, some configurations provide more flexibility or better efficiency than other configurations providing the same final drive ratio.

### SUMMARY

Provided herein is a vehicle having a continuously variable planetary (CVP), wherein the CVP is a ball-type variator assembly having an input traction ring assembly, an output traction ring assembly, and an idler assembly in contact with a plurality of balls, wherein each ball of the plurality of balls has a tiltable axis of rotation; and a controller configured to control a CVP speed ratio and apply a kinematic ratio constraint and a speed-based ratio constraint to a commanded CVP speed ratio operation at unity speed ratio.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the devices are utilized, and the accompanying drawings of which:

FIG. 1 is a side sectional view of a ball-type variator.

FIG. 2 is a plan view of a carrier member that used in the variator of FIG. 1.

FIG. 3 is an illustrative view of different tilt positions of the ball-type variator of FIG. 1.

FIG. 4 is a block diagram schematic of a vehicle control system that can be implemented in a vehicle.

FIG. 5 is a flow chart depicting a speed ratio restriction process that is implementable in the vehicle control system of FIG. 4.

FIG. 6 is a graph depicting an illustrative example of a kinematic speed ratio restriction as a function of torque that is implementable in the speed ratio restriction process of FIG. 5.

FIG. 7 is a graph depicting an illustrative example of a bearing speed based restriction as a function of torque that is implementable in the speed ratio restriction process of FIG. 5.

### DETAILED DESCRIPTION OF THE PREFERRED EMBODIMENTS

An electronic controller is described herein that enables electronic control over a variable ratio transmission having a continuously variable ratio portion, such as a Continuously Variable Transmission (CVT), Infinitely Variable Transmission (IVT), or variator. The electronic controller can be configured to receive input signals indicative of parameters associated with an engine coupled to the transmission. The parameters can include throttle position sensor values, accelerator pedal position sensor values, vehicle speed, gear selector position, user-selectable mode configurations, and the like, or some combination thereof. The electronic controller can also receive one or more control inputs. The electronic controller can determine an active range and an active variator mode based on the input signals and control inputs. The electronic controller can control a final drive ratio of the variable ratio transmission by controlling one or more electronic actuators and/or solenoids that control the ratios of one or more portions of the variable ratio transmission.

The electronic controller described herein is described in the context of a continuous variable transmission, such as the continuous variable transmission of the type described in U.S. patent application Ser. No. 14/425,842, entitled “3-Mode Front Wheel Drive And Rear Wheel Drive Continuously Variable Planetary Transmission” and, U.S. Patent Application Number 62/158,847, entitled “Control Method of Synchronous Shifting of a Multi-Range Transmission Comprising a Continuously Variable Planetary Mechanism”, each assigned to the assignee of the present application and hereby incorporated by reference herein in its entirety. However, the electronic controller is not limited to controlling a particular type of transmission but rather, is optionally configured to control any of several types of variable ratio transmissions.

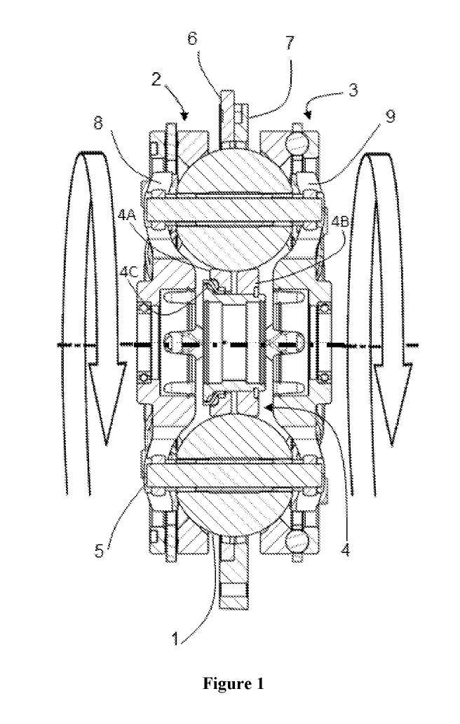

Provided herein are configurations of CVTs based on a ball-type variator, also known as CVP, for continuously variable planetary. Basic concepts of a ball-type Continuously Variable Transmissions are described in U.S. Pat. No. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, as input traction ring assembly 2 and output traction ring assembly 3, and an idler (sun) assembly 4 as shown on FIG. 1.

In some embodiments, the idler assembly 4 includes a first idler ring 4A and a second idler ring 4B in contact with the balls 1. The sun assembly 4 includes an idler support bearing 4C adapted to radially and axially support one of the first idler ring 4A or the second idler ring 4B.

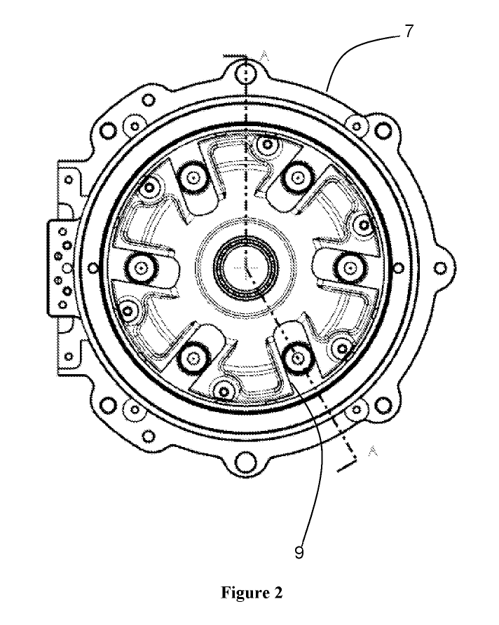

In some embodiments, the output traction ring assembly 3 includes an axial force generator mechanism. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjustable to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

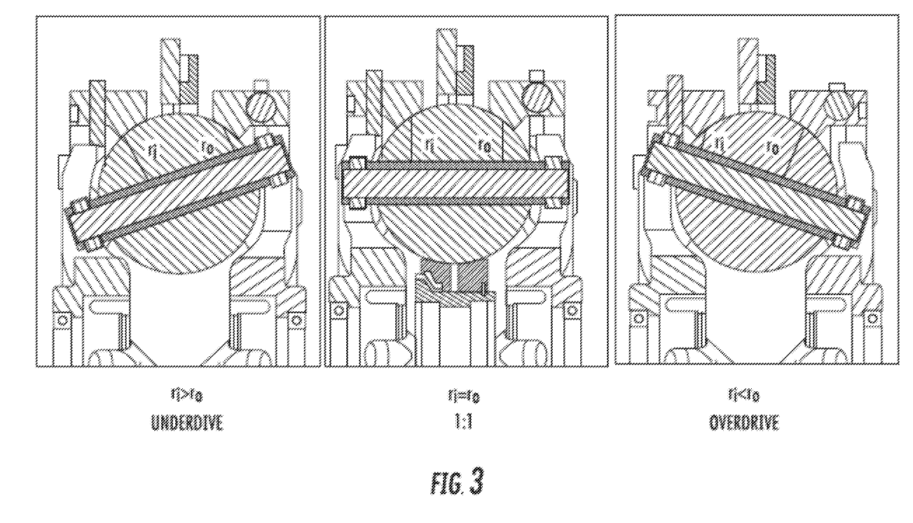

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal, the ratio is one, as illustrated in FIG. 3, when the axis is tilted, the distance between the axis and the contact point change, modifying the overall ratio. All the balls' axes are tilted at the same time with a mechanism included in the carrier and/or idler. Embodiments disclosed herein are related to the control of a variator and/or a CVT using generally spherical planets each having a tiltable axis of rotation that is adjustable to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected”, “operationally coupled”, “operationally linked”, “operably connected”, “operably coupled”, “operably coupleable”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling will take a variety of forms, which in certain instances will be readily apparent to a person of ordinary skill in the relevant technology.

For description purposes, the term “radial”, as used herein indicates a direction or position that is perpendicular relative to a longitudinal axis of a transmission or variator. The term “axial” as used herein refers to a direction or position along an axis that is parallel to a main or longitudinal axis of a transmission or variator.

It should be noted that reference herein to “traction” does not exclude applications where the dominant or exclusive mode of power transfer is through “friction”. Without attempting to establish a categorical difference between traction and friction drives herein, generally, these are understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces that would be available at the interfaces of the contacting components and is a measure of the maximum available drive torque. Typically, friction drives generally relate to transferring power between two elements by frictional forces between the elements. For the purposes of this disclosure, it should be understood that the CVTs described here can operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”. Traction fluid is also influenced by entrainment speed of the fluid and temperature at the contact patch, for example, the traction coefficient is generally highest near zero speed and decays as a weak function of speed. The traction coefficient often improves with increasing temperature until a point at which the traction coefficient rapidly degrades.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer, is referred to as “creep in the rolling direction.” Sometimes the driving and driven elements experience creep in a direction orthogonal to the power transfer direction, in such a case this component of creep is referred to as “transverse creep.”

Those of skill will recognize that the various illustrative logical blocks, modules, circuits, and algorithm steps described in connection with the embodiments disclosed herein, including with reference to the transmission control system described herein, for example, can be implemented as electronic hardware, software stored on a computer readable medium and executable by a processor, or combinations of both. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present embodiments. For example, various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Software associated with such modules can reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor reads information from, and write information to, the storage medium. In the alternative, the storage medium can be integral to the processor. The processor and the storage medium can reside in an ASIC. For example, in one embodiment, a controller for use of control of the CVT includes a processor (not shown).

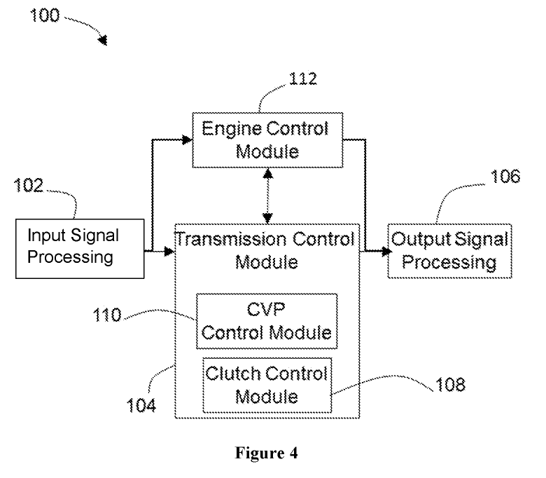

Referring now to FIG. 4, in some embodiments, a vehicle control system 100 includes an input signal processing module 102, a transmission control module 104 and an output signal processing module 106. The input signal processing module 102 is configured to receive a number of electronic signals from sensors provided on the vehicle and/or transmission. The sensors optionally include temperature sensors, speed sensors, position sensors, among others.

In some embodiments, the input signal processing module 102 optionally includes various sub-modules to perform routines such as signal acquisition, signal arbitration, or other known methods for signal processing. The output signal processing module 106 is optionally configured to electronically communicate to a variety of actuators and sensors.

In some embodiments, the output signal processing module 106 is configured to transmit commanded signals to actuators based on target values determined in the transmission control module 104. The transmission control module 104 optionally includes a variety of sub-modules or sub-routines for controlling continuously variable transmissions of the type discussed here. For example, the transmission control module 104 optionally includes a clutch control sub-module 108 that is programmed to execute control over clutches or similar devices within the transmission.

In some embodiments, the clutch control sub-module implements state machine control for the coordination of engagement of clutches or similar devices. The transmission control module 104 optionally includes a CVP control sub-module 110 programmed to execute a variety of measurements and determine target operating conditions of the CVP, for example, of the ball-type continuously variable transmissions discussed here. It should be noted that the CVP control sub-module 110 optionally incorporates a number of sub-modules for performing measurements and control of the CVP.

In some embodiments, the vehicle control system 100 includes an engine control module 112 configured to receive signals from the input signal processing module 102 and in communication with the output signal processing module 106. The engine control module 112 is configured to communicate with the transmission control module 104.

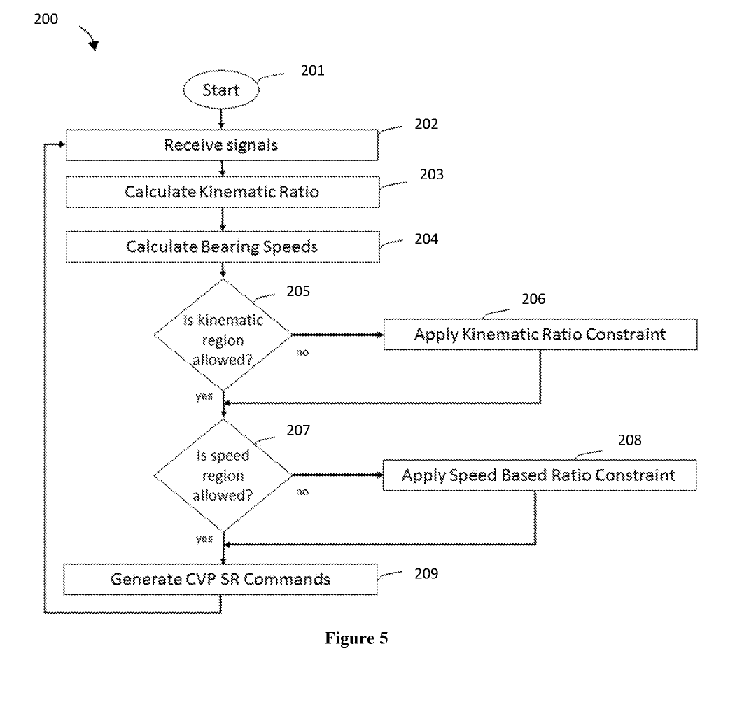

Referring now to FIGS. 5-7, under certain operating conditions, the CVP depicted in FIGS. 1-3 is used as essentially a pass-through device, neither multiplying torque nor extending speed range for much of a drive cycle. Therefore, the CVP operates for a significant amount of time at or near unity (1:1) speed ratio. In some embodiments, the target operating range is based on peak CVP efficiency which occurs near unity speed ratio. Thus, a controls strategy is necessary to extend durability under these specific operating conditions.

During operation at unity speed ratio, there is insufficient speed across the idler support bearing 4C, for example, to maintain adequate lubrication film thickness. The speed difference between the first idler ring 4A and the second idler ring 4B is kinematic with no influence from droop as the idler assembly 4 to ball 1 interface does not transfer torque.

In some embodiments, operation near unity speed ratio allows for one or more thrust bearings (not shown) adapted to react axial loads in the CVP. Under these conditions the speed difference across the thrust bearing is insufficient to maintain an adequate lube film thickness. The thrust bearing speed is influenced by droop at the traction ring to ball interface. Thus, a control method is devised that factors in kinematic idler assembly 4 speeds and droop compensated thrust bearing speeds to target speed ratio commands that result in a minimum speed difference target being satisfied for the current operating conditions.

Turning now to FIG. 5, in some embodiments, a speed ratio restriction process 200 is implemented in the transmission control module 104. The speed ratio restriction process 200 begins at a start state 201 and proceeds to a block 202 where a number of input signals are received.

In some embodiments, the input signals include an input speed, a CVP speed ratio, an input torque, and a CVP actuator position, among others.

In some embodiments, the speed ratio restriction process 200 proceeds to a block 203 where a number of calculations are performed to determine a kinematic ratio for the CVP. The speed ratio restriction process 200 proceeds to a block 204 where a number of calculations are performed to determine bearing speeds. For example, the block 204 determines the speed of the idler support bearing 4C. The speed ratio restriction process 204 proceeds to a first evaluation block 205 where the kinematic ratio determined in the block 203 is compared to a kinematic threshold. If the first evaluation block 205 returns a false result, indicating that the kinematic ratio is not within an allowable threshold or region of operation, then the speed ratio restriction process 200 proceeds to a block 206 where a kinematic ratio constraint is applied to the speed ratio command signal. If the first evaluation block 205 returns a true result, indicating that the kinematic ratio is within the allowable region of operation, then the speed ratio restriction process 200 proceeds to a second evaluation block 207.

The second evaluation block 207 is optionally entered after completion of the block 206. The second evaluation block 207 compares the bearing speeds calculated in the block 204 to an allowable speed threshold or region of operation. If the second evaluation block 207 returns a false result, indicating that the bearing speeds are not in an allowable region of operation, then the speed ratio restriction process 200 proceeds to a block 208 where a speed-based ratio constraint is applied to the speed ratio command signal. If the second evaluation block 207 returns a true result, indicating that the bearing speeds calculated in the block 204 are within the allowable region of operation, then the speed ratio restriction process 200 proceeds to a block 209 where the command signal for the CVP speed ratio is generated and sent to other sub-modules within the transmission control module 104. The speed ratio restriction process 200 returns to the block 202.

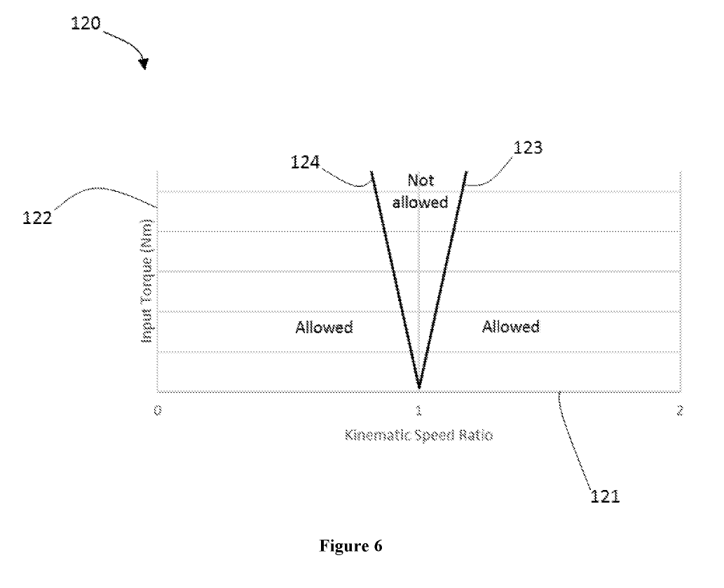

Referring now to FIG. 6, in some embodiments, the first evaluation block 205 evaluates a threshold for kinematic speed ratio that is depicted in a chart 120 of FIG. 6. The chart of FIG. 6 is optionally implemented as a calibration table. The chart 120 has an x-axis representing a kinematic speed ratio 121 and a y-axis representing input torque 122. An overdrive threshold 123 is depicted as a line on the chart 120. An underdrive threshold 124 is depicted as a line on the chart 120. Typically, the region between the overdrive threshold 123 and the underdrive threshold 124 crosses 1:1 speed ratio. The said region is used in the first evaluation block 205 and the block 206 to determine speed ratio constraints based on the kinematic speed ratio.

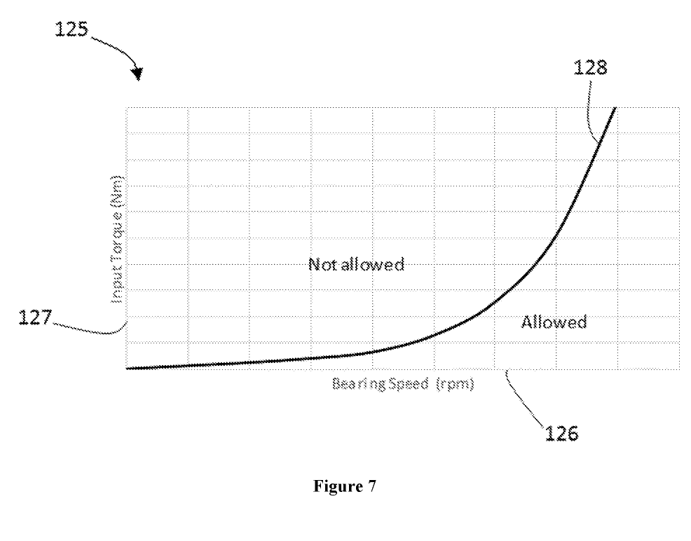

Referring now to FIG. 7, in some embodiments, the second evaluation block 207 evaluates a threshold for bearing speeds as depicted in a chart 125 of FIG. 7. In some embodiments, an explicit control method targeting a minimum speed difference between the first idler ring 4A and the second idler ring 4B for adequate lube film operation is used when the speed ratio constraint is based on the kinematic speed ratio. The minimum speed difference can be defined as a minimum speed or a minimum speed as a function of input torque.

In some embodiments, the idler support bearing 4C speed is calculated at real time and a torque based minimum speed threshold is established as depicted in FIG. 7.

In some embodiments, the chart 125 is also implementable as a calibration table. The chart 125 has an x-axis depicting bearing speed 126. The chart 125 has a y-axis depicting input torque 127. A threshold 128 for minimum allowable thrust bearing speed is depicted as a line on the chart 125.

In some embodiments, it should be appreciated that, a moving threshold 128 is used as the minimum speed of the thrust bearing with droop compensation to satisfy the minimum speed difference, and designed such that the threshold 128 moves in a natural manner in response to road load or driver demand changes is optionally implemented.

For a fixed operating condition, a finite threshold 128 is established as depicted in FIG. 7. Thus, fixed operating conditions results in a static region of allowed operation. The threshold 128 changes when torque or droop changes due to changes in road load or driver demand. This allows a ratio change only in response to driver perceivable occurrences. For example, if the speed ratio command produces a kinematic condition such that expected speed ratio is above unity and droop is such that the effective speed ratio is 1:1, then the threshold 128 does not allow operation in this region and sends a commanded ratio towards underdrive. If the driver reduces the torque demand such that the threshold 128 is exceeded, then the ratio moves naturally back towards overdrive in a manner consistent with driver command.

In some embodiments, the measured input ring 2 speed (“N_{R1}”) is used to calculate the ball 1 speed (“N_{ball}”), the ball 1 radius (“r_{ball}”), traction ring radius (“r_{traction}”), the traction contact radius (“rₚ₁” or “r₁” depicted in FIG. 3), the tilt angle of the ball axle 5 (gamma, “γ”), a contact angle (“α₁”) between the input traction ring 2 and the ball 1, and a contact angle (“α₂”) between the output traction ring 3 and the ball 1, as follows.

$${N}_{ball} = \frac{{N}_{R 1} * {r}_{traction}}{{r}_{p 1}}$$

$${r}_{traction} = {r}_{sun} + {r}_{ball} ( 1 + cos ( {α}_{1} ) )$$

$${r}_{p 1} = {r}_{ball} cos ( {α}_{1} + γ )$$

Next, the ball 1 speed is used to determine the difference in sun speeds (“Nₛᵤₙ_{_}_{difference}”) based on the ratio of the sun contact radii (“rₛ₁” and “rₛ₂”) to the planet, and the contact angle between the idler rings and the ball 1 (“λ₁” and “λ₂”) as follows.

$${N}_{{sun}_{—} difference} = {N}_{ball} - {N}_{ball} * \frac{{r}_{s 2}}{{r}_{s 1}} = {N}_{ball} ( 1 - \frac{{r}_{s 2}}{{r}_{s 1}} )$$

$${r}_{s 1} = {r}_{ball} cos ( {λ}_{1} + γ )$$

$${r}_{s 2} = {r}_{ball} cos ( {λ}_{2} - γ )$$

Note that the sun speed difference calculation is based purely on kinematic geometry and is not impacted by droop because the sun to planet interface does not transmit torque.

The speed across the thrust bearing is simply the difference in ring speeds as shown below.

Nₜₕᵣᵤₛₜ_{_}_{bearing}=N_{R2}−N_{R1}

This automatically accounts for the influence of droop, as the physical manifestation of droop is a reduction in output ring speed.

Kinematic speed ratio is calculated as follows using gamma angle information derived from position sensor:

$${SR}_{kinematic} = \frac{{r}_{p 2}}{{r}_{p 1}} = \frac{{r}_{planet} cos ( {α}_{2} - γ )}{{r}_{planet} cos ( {α}_{1} + γ )}$$

Provided herein is a computer-implemented method for a ball-type variator (CVP) provided with a ball in contact with an input traction ring assembly, an output traction ring assembly, an idler assembly, the method including the steps of: receiving a plurality of data signals provided by sensors located on the CVD and the engine, the plurality of data signals comprising: a CVP speed ratio, an input speed, and a CVP shift position; determining a kinematic ratio based on the CVP shift position; determining a bearing speed of the idler assembly based on the CVP speed ratio and the input speed; comparing the kinematic ratio to a kinematic ratio threshold; comparing the bearing speed to a speed-based threshold; and commanding a CVP speed ratio within the kinematic ratio threshold and the speed-based threshold.

In some embodiments, the kinematic ratio threshold further includes an overdrive threshold and an underdrive threshold. In some embodiments, the data signals further comprise an input torque, and wherein the speed-based threshold is a function of the input torque.

In some embodiments the step of commanding a change in the CVP speed ratio based on the kinematic ratio threshold.

In some embodiments, the method further includes the step of commanding a change in the CVP speed ratio based on the speed-based threshold.

The foregoing description details certain embodiments. It will be appreciated, however, that no matter how detailed the foregoing appears in text, the preferred embodiments are practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the preferred embodiments with which that terminology is associated.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the preferred embodiments described herein can be employed in practicing the preferred embodiments. It is intended that the following claims define the scope of the preferred embodiments and that methods and structures within the scope of these claims and their equivalents be covered thereby.

What is claimed is:

1. A vehicle comprising:
a continuously variable planetary (CVP), wherein the CVP is a ball-type variator assembly having an input traction ring assembly, an output traction ring assembly, and an idler assembly in contact with a plurality of balls, wherein each ball of the plurality of balls has a tiltable axis of rotation; and
a controller configured to control a CVP speed ratio and apply a kinematic ratio constraint and a speed-based ratio constraint to a commanded CVP speed ratio operation at unity speed ratio.

2. The vehicle of claim 1, wherein the controller is adapted to calculate a kinematic speed ratio based on a CVP speed ratio.

3. The vehicle of claim 1, wherein the controller is adapted to determine a bearing speed based on an input speed and an input torque.

4. The vehicle of claim 2, wherein the controller is adapted to determine a kinematic speed ratio threshold based on an input torque.
